(19) United States
(12) Patent Application Publication
(10) Pub. No.: US 2010/0059375 A1
(43) Pub. Date: Mar. 11, 2010

(54) Metal salt hydrogen sulfide sensor

(76) Inventors: Bruce H. Weiller, Santa Monica, CA (US); Richard B. Kaner, Pacific Palisades, CA (US); Shabnam Virji, Yorba Linda, CA (US)

Correspondence Address: KOPPEL, PATRICK, HEYBL & DAWSON, 2815 Townsgate Road, SUITE 215, Westlake Village, CA, 91361-5827, US

(21) Appl. No.: 11/594,515

(22) Filed: Nov. 8, 2006

(51) Int. Cl. G01F 1/64

(52) U.S. Cl. 204/433

(57) ABSTRACT

A hydrogen sulfide sensor is made from a metal acetate film, such as a thin film of copper acetate, formed on a set of monitoring electrodes, by evaporation of a metal acetate aqueous solution disposed on the electrodes, for detecting a weak gas, such as hydrogen sulfide, carried in a gas carrier, such as a nitrogen carrier, for detecting low concentration of the weak gas, such as ten ppm, when the conductivity of the film changes by several orders of magnitude, that produces a metal sulfide, such as copper sulfide, that is a good electrical conductor at room temperature, for example, as the metal acetate is converted directly to a metal sulfide upon exposure to hydrogen sulfide.

### FIELD OF THE INVENTION

The invention relates to the field of chemical sensors for detecting hazardous gases. More particularly, present relates to hydrogen sulfide chemical sensors.

### BACKGROUND OF THE INVENTION

Conducting polymers, such as polyaniline, have been widely studied as chemical sensors due to simple and reversible acid doping and base dedoping chemistry. Polyaniline is a conducting polymer that has been widely studied for electronic and optical applications. Unlike other conjugated polymers, polyaniline has a simple and reversible acid doping and base dedoping chemistry enabling control over properties such as free-volume, solubility, electrical conductivity, and optical activity. One-dimensional polyaniline nanostructures, including nano-wires, rods, and tubes have been studied with the expectation that such materials will possess the advantages of being low-dimensional systems and organic conductors. The change in conductivity associated with the transition from the insulating emeraldine base to the conducting emeraldine salt form of polyaniline is over ten orders of magnitude. This wide range in conductivity has been utilized to make polyaniline sensors that can detect either acids or bases. Polyaniline is widely studied as conducting polymers because of polyaniline environmental stability and straightforward synthesis. Polyaniline is a useful material for chemical sensors because polyaniline conductivity can change in the presence of doping and dedoping agents. In the undoped state, insulating emeraldine oxidation, polyaniline is a suitable material for chemical sensors because the conductivity can increase by over ten orders of magnitude on exposure to doping acids. This doping process can be reversed during dedoping when exposed to bases. Polyaniline is difficult to process from solution and much effort has been directed toward the improvement of polyaniline solubility. N-methyl-pyrrolidinone (NMP), m-cresol, formic acid, and hexafluoro-isopropanol (HFIP) are among the various solvents that have been used to process polyaniline. The conductivity of doped polyaniline is different for each of these solvents due to the difference in the reactions between the polymer chain and the solvent used. Using NMP, polyaniline tends to coil up, and as a result, has low solubility in this solvent. On the other hand, in m-cresol and HFIP polyaniline adopts an expanded coil conformation leading to high conductivity of about 400.0 S/cm. Among these solvents, HFIP is favored for processing polyaniline because HFIP has a low boiling point of 59° C. and can dissolve both the emeraldine salt and emeraldine base form of polyaniline.

Polyaniline sensors have been used to detect a number of different chemical species including hydrochloric acid HCl, ammonia NH₃, organic vapors, and strong reducing agents such as hydrazine. Conventional polyaniline films processed from other organic solvents and polyaniline nanofiber films processed from water become more insulating upon exposure to hydrazine. In these cases, hydrazine acts as a strong reducing agent, converting the emeraldine salt form of polyaniline to the leucoemeraldine oxidation form.

Polyaniline nanostructures have received attention as chemical sensors due to their high surface area, porosity, and small diameters that enable rapid and facile diffusion of molecules and dopants into the nanofibers. Current chemical methods of making polyaniline nanostructures, including tubes, wires, rods, and fibers, which involve complex synthetic conditions that require the removal of templates which leads to lower yields with less reproducibility. A practical bulk synthetic template-free method is capable of producing pure uniform nanofibers with small diameters. The polyaniline nanofibers respond rapidly to organic vapors, reducing agents, strong acids, and strong bases significantly better than conventional polyaniline bulk films in all cases. Other work on nanostructured polyaniline as gas sensors has also shown that the creation of nanostructures leads to better gas diffusion because of small diameters. Polyaniline nanofibers with uniform diameters between 30 nm and 50 nm can be made in bulk quantities through a facile aqueous and organic interfacial polymerization method at ambient conditions. Thin film sensors made of polyaniline nanofibers have superior performance in sensitivity and in time response to a variety of gas vapors including, acids such as hydrochloric acid HCl, bases such as ammonia NH₃ and butylamine, and alcohols including methanol, ethanol, and propanol. However there are a number of gases that cannot be detected by the standard, unmodified forms of polyaniline nanofibers.

High quality polyaniline nanofibers have been produced under ambient conditions using aqueous and organic interfacial polymerization. Polyaniline nanofiber films possess much faster doping and dedoping times than conventional cast films and have been used in sensor applications. The nanofibers have nearly uniform diameters between 30.0 nm and 50.0 nm with lengths varying from 500.0 nm to several microns. Gram scale products can be synthesized that contain almost exclusively nanofibers. The synthesis is based on the chemical oxidative polymerization of aniline in a strongly acidic environment, with ammonium peroxy-disulfate as the oxidant. Instead of using the traditional homogenous aqueous solution of aniline, acid, and oxidant, the polymerization is performed in an immiscible organic and aqueous biphasic system, in order to separate the by-products, such as inorganic salts and oligomers, according to solubility in the organic and aqueous phases. However there are a number of gases that cannot be detected by standard, unmodified forms of polyaniline nanofibers. These include hydrazine and hydrogen sulfide H₂S.

Detection of hydrazine, monomethyl-hydrazine, and unsymmetrical dimethyl-hydrazine, is important because these chemicals are widely used as rocket fuels but have low harmful threshold limit values of from 1.0 to 10.0 ppb. Hydrazine has also been implicated in terrorist incidents. Previous work on conducting polymer based hydrazine sensors includes using both polypyrrole and polythiophene as the detecting material. Polythiophene sensors can measure very low concentrations of hydrazine, on the parts-per-billion level, but polythiophene is air sensitive and subject to degradation when stored at room temperature. Polypyrrole sensors are air stable but have high detection limits of one percent.

Additives have been used in biosensors to increase sensitivity of polymers to analytes like glucose, urea, oxygen, and chloride. For example, carbon nanotubes have been fluorinated. Single walled carbon nanotubes can be defluorinated with anhydrous hydrazine to produce hydrogen fluoride and nitrogen. Hydrazine reacts with fluorinated alcohols, such as HFIP or hexafluorophenyl-isopropanol (HFPP), and hydrogen fluoride acid is produced. When HFIP is added to aqueous solutions of hydrazine, there is a strongly exothermic reaction with a large decrease in pH from 11.0 to 3.0.

Hydrazine is a strong reducing agent and is known to reduce both doped and dedoped polyaniline from a half oxidized polyaniline emeraldine oxidation state to a fully reduced polyaniline leucoemeraldine state. Reduction by hydrazine causes a conversion of polyaniline emeraldine to the polyaniline leucoemeraldine insulating state. This transformation leads to an increase in resistance as is observed for both the polyaniline nanofiber and conventional bulk polyaniline. Because leucoemeraldine is electrically insulating, the decrease in conductivity associated with the conversion change can be used to develop polyaniline hydrazine sensors. Doped polyaniline nanofibers respond to hydrazine with an increase in resistance and a corresponding change in structure from emeraldine salt state to leucoemeraldine. The same type of change occurs for conventional polyaniline processed from NMP, but the increase in resistance is much smaller. The direct detection of hydrazine with polyaniline is possible but the response is disadvantageously small.

Hydrogen sulfide is weak acid that is important to detect because it is a colorless and flammable gas that is heavier than air and has the ability to cause lung paralysis and death. Generally, a weak acid has a pKₐ value of less than 10.0. Hydrogen sulfide detection is necessary because of the potential use in terrorist attacks. Hydrogen sulfide is a toxic dense gas that has a pungent odor and can be fatal at high concentrations greater than a hundred ppm. Hydrogen sulfide has a permissible exposure limit of twenty ppm but the human odor threshold is about five ppb. Odor alone cannot be used as an indicator of exposure because the sense of smell is lost upon continuous exposure to hydrogen sulfide. As a result, sensitive and reliable hydrogen sulfide sensors are needed with detection thresholds below five ppb.

Existing hydrogen sulfide detection sensors include conductive metal oxides such as tin oxide and tungsten oxide, but these sensors generally require high temperatures for operation. Paper tapes impregnated with metal salts are also useful and rely on the reaction of the hydrogen sulfide with metal salts. Paper tape sensors disadvantageously need a relatively bulky reader with large power requirements and provide only a limited dynamic range of the measurement. Despite the disadvantages of impregnated paper tapes, the tapes utilize an important property of hydrogen sulfide for detection, namely, the ability to react chemically with metals and metal ions. The reaction of hydrogen sulfide with metal ions forms metal sulfides that can be used to detect hydrogen sulfide H₂S. Paper tapes along with direct optical methods for sulfide measurement, utilize absorption for detection.

Strong acids have the ability to fully dope polyaniline resulting in large changes in conductivity. Polyaniline gives a robust response to strong acids because the strong acids have the ability to fully dope polyaniline resulting in very large changes in conductivity. However, weak acids, such as hydrogen sulfide, only partially dope the polymer and the response of polyaniline to hydrogen sulfide is reduced. That is, weak acids only partially dope the polyaniline polymer, requiring much more weak acid to fully dope the polyaniline. Films of the unmodified polyaniline nanofibers do not significantly change resistance when exposed to hydrogen sulfide. Metal sulfides, in general, are not good electrical conductors except for one, copper sulfide. Hydrogen sulfide reacts with many metal salts in solution to form a metal sulfide precipitate and a strong acid as the by-product as in the reaction of H₂S+MCl₂→MS+2HCl, where MCl₂ is a metal chloride salt. Being a weak acid, hydrogen sulfide does not interact with polyaniline significantly. Conventional polyaniline responds to ten ppm of gaseous hydrogen sulfide by a small conductivity change. At room temperature and pressure, hydrogen sulfide dissociates only slightly in the presence of water into H⁺ and HS⁻ because hydrogen sulfide is a weak acid with a pKₐ=7.05. Therefore, polyaniline can only be partially protonated by hydrogen sulfide with a small decrease in resistance. Both doped and dedoped forms of polyaniline nanofibers have been exposed to ten ppm of hydrogen sulfide in a humid environment. Both bulk and nanofiber polyaniline respond only weakly to hydrogen sulfide with the dedoped form polyanline responding slightly better than the doped form. The dedoped nanofiber film have only a twenty percent resistance change. The doped nanofiber film shows almost no change in resistance upon exposure to hydrogen sulfide. The unmodified polyaniline nanofiber films provide poor sensory detection of hydrogen sulfide. Other weak gases of interest, such as hydrogen cyanide HCN, hydrogen selenide H₂Se, arsine AsH₃, phosphine PH₃ and other related hydride molecules are practically undetectable by unmodified forms of polyaniline nanofibers.

Copper salts are known to react with hydrogen sulfide both in solution and in the solid state. Copper acetate reacts with hydrogen sulfide in water to produce an insoluble copper sulfide precipitate that is black in color. Copper acetate also reacts with hydrogen sulfide in organic solutions to produce organosols. Copper sulfide films have been deposited using atomic layer deposition from the surface reaction of a copper β-diketonate and hydrogen sulfide. Copper acetate films have also been shown to react directly with hydrogen sulfide to form copper sulfide. Copper acetate films are highly insulating and the ability to measure high resistances has been limited.

The conductivity and solubility product constants of metal sulfides are known. The solubility product constant is a parameter for measuring the aqueous solubility of a sparingly soluble material. When a salt is dissolved in water, the salt dissociates into cations and anions and the solubility product constant is the product of the combined ion concentrations. A smaller solubility product constant indicates a less-soluble salt that is therefore more stable. The conductivity (S/cm) and the solubility products (Ksp) of metal sulfides include CoS at 5×10⁻⁸ S/cm, NiS at 1×10⁻⁷ S/cm and 1.1 Ksp, PbS at 1×10⁻³ S/cm and 3×10⁻⁷ Ksp, HgS at 6×10⁻³ S/cm and 2×10⁻³² Ksp, PdS at 1×10⁻³ S/cm and 2×10⁻³⁷ Ksp, and CuS at 10.0 S/cm and 6.0×10⁻¹⁶ Ksp. Palladium sulfide has the smallest solubility product constant with palladium being the most stable metal sulfide. Nickel sulfide has the largest solubility product constant and is the least stable metal sulfide. Copper sulfide is the most conducting of the metal sulfides. Copper sulfide is known to be conducting but has not been used as an acid sensing materials. Existing hydrazine and hydrogen sulfide sensors are largely ineffective, insensitive, or expensive in use. Hydrazine and hydrogen sulfide are undetectable by pure conventional dope and dedoped polyaniline. These and other disadvantages are solved or reduced using the invention.

### SUMMARY OF THE INVENTION

An object of the invention is to provide a sensor for detecting a weak acid.

Another object of the invention is to provide a hydrogen sulfide sensor using metal salt.

Yet another object of the invention is to provide hydrogen sulfide sensor using metal acetate, such as copper acetate.

The invention is directed to weak acid sensor using a metal salt. More specifically, the metal salt is a form of metal acetate. In the preferred form, the weak acid is hydrogen sulfide that can be detected by the sensor using copper salt. The detection of hydrogen sulfide H₂S with improved sensitivity can be had in the absence of a supporting matrix, such as polyaniline. In the preferred form, a film of a copper salt is disposed on electrodes without the supporting matrix, to directly detect hydrogen sulfide acid H₂S through a reaction with the copper salt. The reaction produces copper sulfide at room temperature for providing improved conductivity change of about eight orders of magnitude. The preferred copper salt is copper acetate. The metal salt film reacts with hydrogen sulfide to form metal sulfide films directly at room temperature resulting in very large conductivity changes induced by only parts per million of hydrogen sulfide. Direct electrical measurement of the chemical transformation can be used as a method for monitoring or detecting trace amounts of hydrogen sulfide. Electrical detection of metal sulfide formation is directly made by monitoring the electrical conductivity of metal salt film as the film reacts with hydrogen sulfide to form metal sulfides at room temperature. Discovery is made that copper acetate can be directly used to detect trace amounts of hydrogen sulfide. The sensor can be fabricated as a small and sensitive sensor based on direct electrical measurements at room temperature. These and other advantages will become more apparent from the following detailed description of the preferred embodiment.

### BRIEF DESCRIPTION OF THE DRAWINGS

FIG. 1 depicts a chemical reaction of copper acetate and hydrogen sulfide.

FIG. 2 depicts a process flow for making a hydrogen sulfide sensor using copper acetate.

FIG. 3 depicts a hydrogen sulfide sensor using a metal acetate film.

FIG. 4 is a graph showing responses to hydrogen sulfide to metal acetate films.

### DETAILED DESCRIPTION OF THE PREFERRED EMBODIMENT

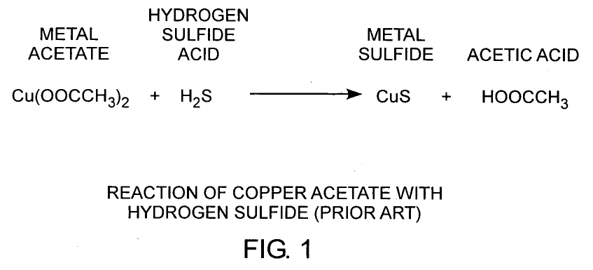

An embodiment of the invention is described with reference to the figures using reference designations as shown in the figures. Referring to FIG. 1, copper acetate Cu(CH₂COO⁻)₂ reacts with hydrogen sulfide acid H₂S to form copper sulfide and acetic acid HOOCCH₃. Copper sulfide is conducting. When a copper acetate film is exposed to hydrogen sulfide, a weak acid, the conductivity of the film changes. As such, copper acetate films can be used as a hydrogen sulfide detector.

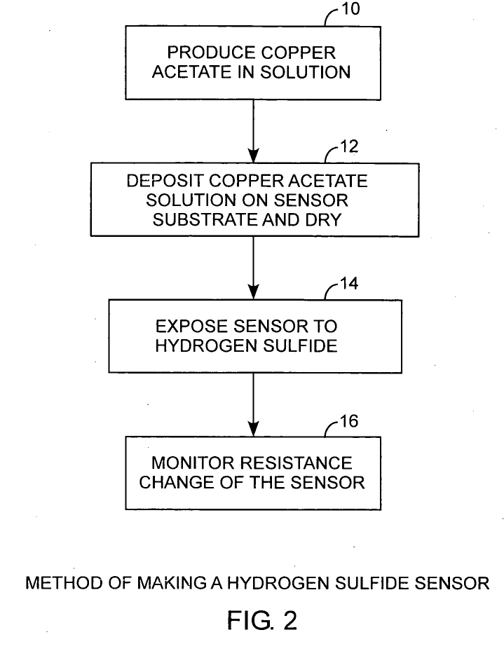

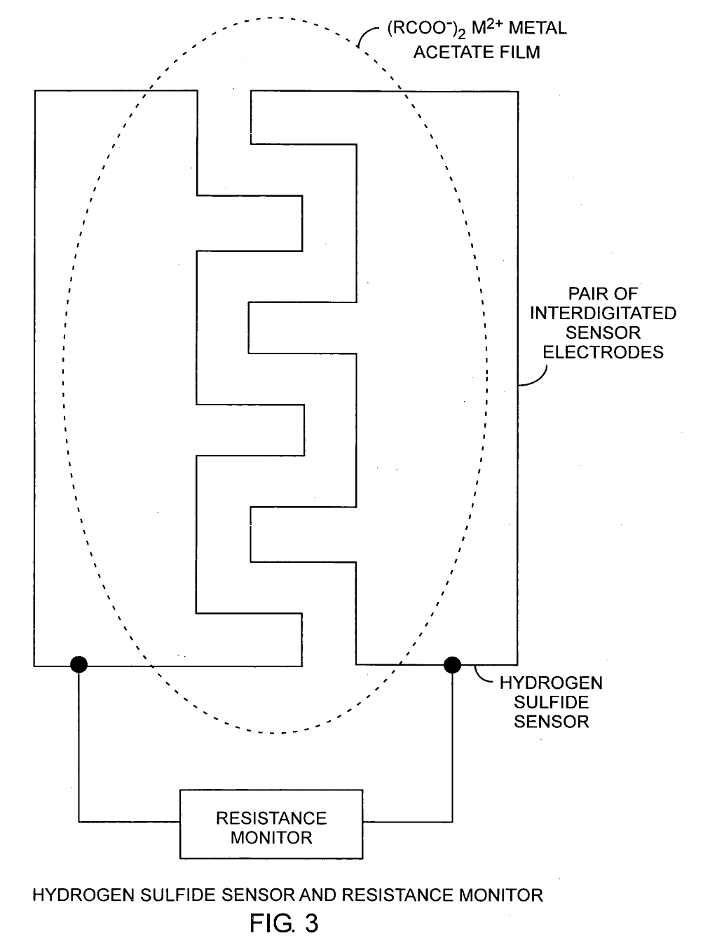

Referring to FIGS. 1, 2, and 3, and more particularly to FIGS. 2 and 3, a hydrogen sulfide sensor is made by producing 10 a metal salt, such as copper acetate, in solution and depositing and drying 12 the copper acetate on a sensor substrate. In practice, when the sensor is exposed 14 to hydrogen sulfide, a resistance monitor can be used to measure the change in resistance for detecting the presence of hydrogen sulfide. A pair of electrodes is disposed on the sensor substrate and is used to make electrical contact with the film. The film is a metal salt film, and is preferably a metal acetate film M²⁺ (RCOO⁻)₂ consisting of a metal M²⁺ and an acetate (RCOO⁻)₂ where R is a radical that is preferably CH₃CH₂ or CH₃. The metal M is preferably selected from a metal group consisting of cobalt Co, nickel Ni, lead Pb, mercury Hg, and copper Cu. The weak acid includes hydride molecules that do not dope unmodified forms of polyaniline films. The weak acid is preferably selected from a weak acid group consisting of hydrogen sulfide H₂S, hydrogen cyanide HCN, hydrogen selenide H₂Se, arsine AsH₃, and phosphine PH₃.

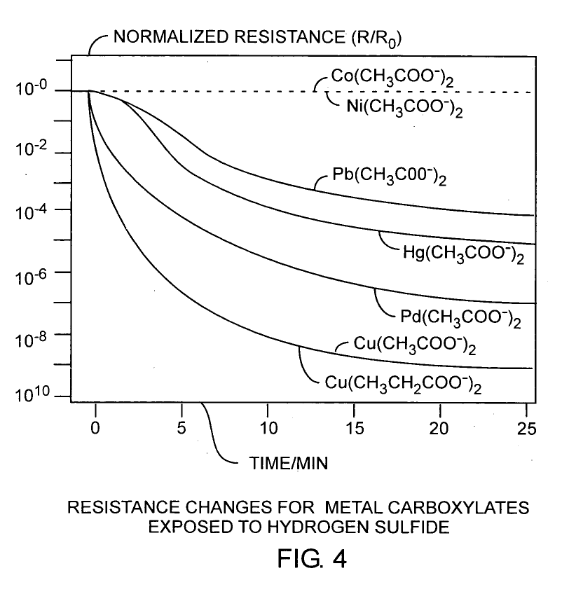

Referring to all of the figures, and more particularly to FIG. 4, most metal acetate films experience a dramatic reduction in resistance when exposed to a weak acid, such as hydrogen sulfide. In an exemplar procedure, copper acetate is dissolved in water to give a final concentration of 0.1 M. A drop of the resulting solution is then placed on a set of interdigitated gold electrodes on the substrate so as to form a thin film of copper acetate on the substrate. The sensor may be a sensor array consisting of multiple sensors. Each sensor may have fifty pairs of conducting figures of the electrodes disposed on a glass substrate with gaps of 10.0 μm between the fingers. The resistance change of a thin film of copper acetate can be measured upon exposure to hydrogen sulfide H₂S at 10.00 ppm at room temperature. The resistance is plotted as R/R₀ where R₀ is the resistance before exposure and R is the resistance after exposure. The real time resistance change of a film of copper acetate upon exposure to hydrogen sulfide H₂S is eight orders of magnitude.

A flow of a predetermined hydrogen sulfide H₂S concentration is generated using a calibrated gas mixture of 200.0 ppm of hydrogen sulfide in nitrogen that is diluted with a humidified nitrogen stream using calibrated mass flow controllers. The humidity can be generated using a bubbler and humidity sensor. The copper acetate film responds quickly and strongly to an exposure of hydrogen sulfide H₂S. The change of resistance can be eight orders of magnitude in minutes. Of the metal salts, copper acetate provides the largest response. Copper sulfide is the preferred conducting sulfide of the expected products from the reaction of hydrogen sulfide with the metal salts. Copper sulfide CuS conducts better than cadmium sulfide CdS, lead sulfide PbS, and zinc sulfide ZnS. As such, a copper salt gives a large response relative to the other metal salts. Some metal salts, such as copper chloride CuCl₂ and other related metal chlorides and nitrates do not react with hydrogen sulfide directly in the solid state. However, copper acetate and related salts do react directly to hydrogen sulfide as sensitive materials for hydrogen sulfide detection. The use of an electrometer monitor with a very large dynamic range and the interdigitated electrodes enables monitoring of the resistance changes associated with the conversion of copper acetate to copper sulfide that is a small band gap semiconductor with a conductivity of 10.0 S/cm. The sensor does not require a high temperature and can be used at room temperature. The change in conductivity is rapid with a time response on the order of τ₉₀=3.8 seconds where τ₉₀ is the response to 90% of full scale. At 100.0 ppb of hydrogen sulfide, copper acetate responds with over five orders of magnitude decrease in resistance with a time response of under one minute. This large change is attributed to the direct conversion of a very insulating starting material having a high initial resistance to a highly conducting copper sulfide product having a low final resistance.

Copper acetate is an excellent material for sensing hydrogen sulfide with much larger changes in conductivity than other copper chloride or composites of copper acetate or copper chloride with polyaniline because copper acetate films react readily with hydrogen sulfide. Chloride ions are much more tightly bound to the metal center than acetate ions and, as a result, metal chlorides show no direct response to hydrogen sulfide. Unmodified polyaniline nanofibers show no response to hydrogen sulfide because hydrogen sulfide H₂S is a weak acid and cannot sufficiently dope unmodified forms of polyaniline when used as a sensor. However, copper acetate is one of several copper salts that do respond directly to hydrogen sulfide. Other copper salts with large ligands, including copper formate and copper butyrate, respond to hydrogen sulfide with resistance changes of several orders of magnitude. In particular, copper propionate responds similarly to copper acetate. Carboxylates includes both acetates (CH₃OO⁻)₂ and propionates (CH₃CH₂COO⁻)₂. Other metal acetates including lead Pb, mercury Hg, and palladium Pd also respond well to hydrogen sulfide forming respective metal sulfides after exposure. Silver acetate has a response similar to lead acetate. Salts can be used for detecting other weak acids, for example, chloroauric acid HAuCl₄ can be used to detect arsine AsH₃. The differences in response of various metal acetates can be attributed to the initial resistances of the starting materials and the conductivities and solubility product constants of the resulting metal sulfides.

The response to hydrogen sulfide is dependant on the solubility product constant and conductivity of the resulting metal sulfide. Copper responds the best because copper sulfide has a relatively small solubility product constant and a high conductivity. Mercury Hg, lead Pb, and palladium Pd sulfides have similar conductivities but respective solubility product constants are different. The difference in response to hydrogen sulfide is related to the difference in respective solubility constants. Cobalt sulfide CoS and nickel sulfide NiS are essentially insulating and have high solubility product constants, which is consistent with the absence of a significant response to hydrogen sulfide.

The invention is directed to a simple weak acid sensor using metal salt films. The sensor can respond to 100 ppb weak acid gas, or lower. The sensor is extendable to other toxic weak acid gases such as hydrogen cyanide HCN, hydrogen selenide H₂Se, arsine AsH₃, phosphine PH₃, and others through the formation of other conductive semiconductors from reactions of metal salts with these gases. Copper acetate films are preferred for sensitive hydrogen sulfide detection because copper acetate films respond with very large changes in resistance through the formation of a conductive product, such as the copper sulfide product. The response times are on the order of seconds to a couple of minutes at room temperature. Other copper salts with large, weakly bound ligands and other metal acetates also respond to hydrogen sulfide by forming metal sulfides. Those skilled in the art can make enhancements, improvements, and modifications to the invention, and these enhancements, improvements, and modifications may nonetheless fall within the spirit and scope of the following claims.

1. A sensor for detecting a weak acid, the sensor comprising,
a substrate,
a pair of electrodes on said substrate, and a metal salt in contact with the pair of electrodes,
wherein an electrical characteristic of the metal salt changes when the metal salt is exposed to a weak acid,
said change in electrical characteristic being sufficient for display by an external monitor.

2. The sensor of claim 1 wherein,
the weak acid is hydrogen sulfide.

3. The sensor of claim 1 wherein,
the weak acid is selected from the group consisting of hydrogen sulfide, hydrogen cyanide, hydrogen selenide, arsine and phosphine.

4. The sensor of claim 1 wherein,
the electrode comprises polyaniline nanofibers and the weak acid comprises hydride molecules that do not dope unmodified forms of the polyaniline nanofibers.

5. The sensor of claim 1 wherein,
the metal salt is a metal acetate consisting of a metal ion with a +2 valence and an acetate ion having the formula (CH₃COO⁻)₂.

6. The sensor of claim 5 wherein,
the metal is selected from the group consisting of cobalt, nickel, lead, mercury and copper.

7. The sensor of claim 1 wherein,
the metal salt is a copper acetate.

8. The sensor of claim 1 wherein,
the metal salt is chloroauric acid and the weak acid is arsine.

9. The sensor of claim 1 wherein,
the weak acid is selected from the group consisting of hydrogen sulfide, hydrogen cyanide, hydrogen selenide, arsine, and phosphine PH₃,
the metal salt is a metal acetate, and
the metal is selected from the group consisting of cobalt, nickel, lead, mercury and copper.

10. A method of forming a sensor for detecting the presence of a weak acid comprising the steps of,
disposing a pair of electrodes on a substrate, forming a metal salt solution,
placing sufficient metal salt solution on the substrate in contact with each of the pair of electrodes, and
evaporating the metal salt solution on the electrodes using dried air.

11. A method for forming a sensor for detecting the presence of a weak acid comprising the steps of,
disposing a pair of electrodes on a substrate,
forming a metal salt solution,
placing sufficient metal salt solution on the substrate in contact with each of the pair of electrodes, and
evaporating the metal salt solution on the electrodes using heated oven air.

12. The sensor of claim 1 wherein,
the metal salt is copper formate.

13. The sensor of claim 1 wherein,
the metal salt is copper butyrate.

14. The sensor of claim 1 wherein,
the metal in the metal salt comprises copper.

15. The sensor of claim 1 wherein,
the metal salt is an insulating metal salt convertible to an electrically conducting material by, a reaction between the metal salt and the weak acid.

16. The sensor of claim 15 wherein,
a reaction between the metal salt and the weak acid to produce a conducting product occurs at room temperature.

17. The sensor of claim 16 wherein,
the metal salt comprises atoms bound together by large ligands that are broken by a reaction of the metal salt with the weak acid.

18. The sensor of claim 1 wherein,
the metal salt is copper acetate,
and
the weak acid is hydrogen sulfide.

19. A sensor for detecting hydrogen sulfide, the sensor comprising,
a substrate,
a pair of electrodes on said substrate,
a metal salt in contact with the the pair of electrodes, the metal salt comprising copper sulfate
wherein the electrical resistance of the copper sulfate changes when exposed to hydrogen sulfide
said change in electrical resistance being sufficient for display by an external monitor.

20. A method of forming an electrode for detecting hydrogen sulfide comprising the steps of,
disposing a pair of electrodes on a substrate
forming a copper acetate solution,
placing sufficient copper acetate solution on the substrate in contact with each of the pair of electrodes, and
evaporating the copper acetate solution on the electrodes.
